(19) United States
(12) Patent Application Publication
(10) Pub. No.: US 2007/0218431 A1
(43) Pub. Date: Sep. 20, 2007

(54) Interactive learning appliance and method

(76) Inventors: Cheng-Chih Chien, Bali Township (TW); Chih-Yung Cheng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/377,545

(22) Filed: Mar. 17, 2006

(51) Int. Cl. G09B 19/00

(52) U.S. Cl. 434/155

(57) ABSTRACT

A method and an appliance for interactive learning mainly comprise a plurality of pieces and a stage. After a user placing at least one piece on the stage, the stage will identify and judge if a combination formed by the at least one piece is meaningful and output a corresponding content package explaining a meaning of the combination subsequently.

### TECHNICAL FIELD

This invention relates generally to educational appliances and methods for providing a user with a fun interactive learning experience.

### BACKGROUND OF THE INVENTION

It's been a long time that people desire to learning with fun. To date, all attempts to have a fun learning through the use of educational tools. A conventional learning tool, for example, a jigsaw puzzle or a spelling game is familiar.

However, no matter what the spelling result comes out, it suffers from a disadvantage of providing pleasant looking only but not teaching anything else. The meanings of the outcome need to be analyzed and interpreted by a human being. For example, the characters, such as B-O-O-K spelled by a child, need to be read and explained by an adult. A further example is a famous-painting puzzle which could only be understood through a manual specifying an author, a background and a comment of the famous painting.

No matter what, these kinds of toys, such as the jigsaw puzzles or the spelling games have the common object to provide with a fun learning experience, but the learning efficiency is inferior. A user needs assistance from other persons to obtain satisfied learning effect. From the foregoing, there is still room for providing a new learning appliance and method that improves the learning efficiency in fun, easy-to-use way.

### SUMMARY OF INVENTION

It is therefore an object of this invention to provide a method and an appliance with mainly a plurality of pieces and a stage. After a user places at least one selected piece on the stage, the stage will identify and judge the meaning of the combination formed by the selected pieces and then render immediate feedback of explaining the meaning of the combination.

The present invention discloses plural embodiments for identifying the combination in accordance with the information of the positions and identifications of the selected pieces placed on the stage via plural technologies, such as photographic technologies, graphics technologies, barcode identification technologies, radio frequency identification (RFID) technologies or optical detection technologies. After the combination is determined to be meaningful, an output module installed in the stage is driven so as to output a content package which explains the meaning of the combination via an audio or a video device. For example, when pre-shaped selected pieces are placed on the stage and arranged as a combination as B-O-O-K, the stage correspondingly renders immediate feedback with a pronunciation, an explanation, an instruction and an example sentence of the word “book”. Comparing with the conventional jigsaw puzzle or spelling toy which is just for pleasant looking only, the present invention expresses the meanings of the combination via audio, video or other method so that the user may have the interactive learning with more fun and improve the learning efficiency. It is also very helpful especially for preschool-aged children or blind people.

### BRIEF DESCRIPTION OF DRAWINGS

These and other features, aspects and advantages of the present invention will become better understood with reference to the following description, appended claims, and accompanying drawings wherein:

FIG. 1 is a perspective view of a preferred embodiment of the present invention, showing an interactive learning appliance comprising plural pieces and a stage;

FIGS. 2 to 5 show different practices of the pieces of the interactive learning appliance;

FIG. 6 is block diagram of the present invention; and

FIGS. 7 to 10 are block diagrams of the present invention, showing different practices of identification modules.

### DETAILED DESCRIPTION OF PREFERRED EMBODIMENTS

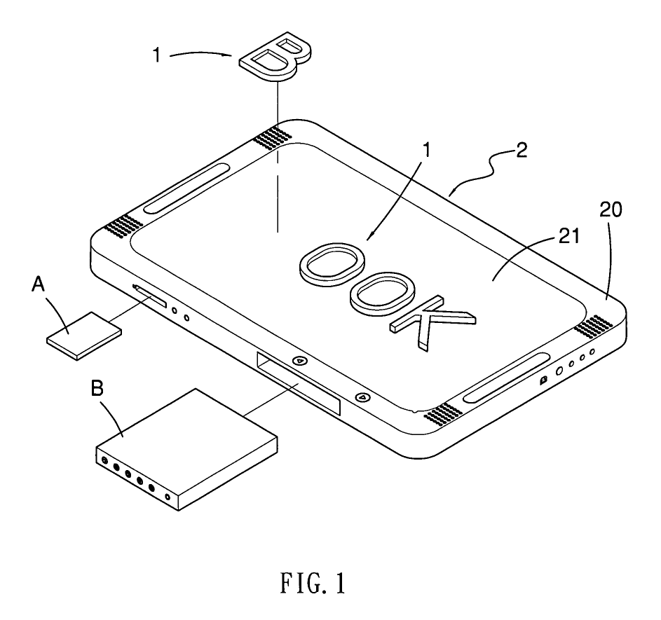

As shown in FIG. 1, a learning appliance embodied in the present invention mainly comprises plural pieces 1 and one stage 2. Although the FIG. 1 shown here has four different pieces (pieces of one B-shaped, two O-shaped and one K-shaped), it is to be understood that any other shape for educational and entertaining purpose can be devised, such as other English characters, Chinese characters, phonetic symbols, animals, plants or jigsaws. Moreover, the plural pieces 1 are devised to be selected and arranged on the stage 2 to form a combination of the selected pieces 1, and the stage 2 is designed to identify the meaning of the combination and then to output and specify the meaning of the combination in a percipient way.

On the other hand, the present invention discloses an improved method for interactive learning, and the method comprises the following steps: providing the stage 2 and the plural pieces 1 arranged for placing on the stage 2; creating a corresponding content package for each of possible meaningful combinations of the plural pieces 1; identifying whether a combination formed by the selected pieces 1 is meaningful, wherein the selected pieces 1 are chosen from the plural pieces 1 and are arranged on the stage 2 by a user; and outputting the corresponding content package for explaining the meaning of the combination of the selected pieces 1 in a percipient way.

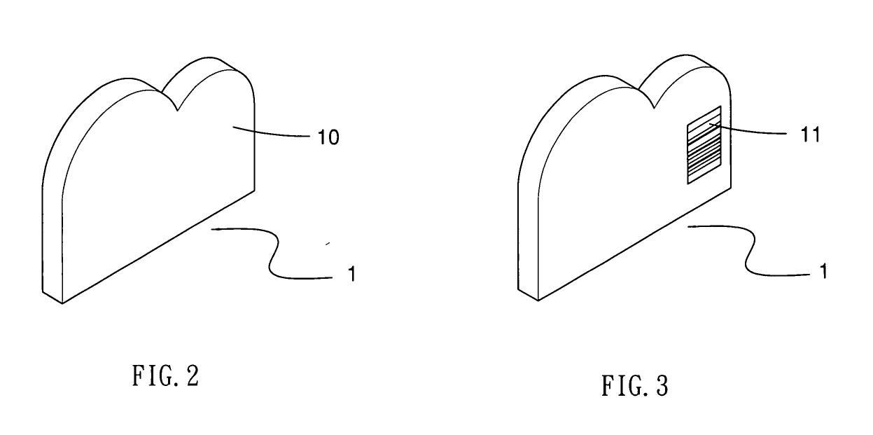

FIGS. 2 to 5 illustrate how to identify the combination according to the preferred embodiment of this subject invention.

In a first practice, each of the plural pieces 1 facing to the stage 2 is formed of a shaped face 10 as shown in FIG. 2. First, recognize each of the positions and the shaped faces 10 of the selected pieces 1 placed on the stage via imaging and photographic technologies and graphics technologies so that identifications of the pieces 1 are created. According to the positions of the selected pieces 1 and the identifications transformed via the shaped faces 10 of the selected pieces 1, create information about the combination of the selected pieces 1, such as the combination of “BOOK”, as shown in FIG. 1. Then, identify whether the combination is within a pre-built database made up of plural meaningful combinations, such as text combinations, graphic combinations or text-graphic mixed combinations so as to determine whether the combination of the selected pieces 1 placed on the stage 2 is meaningful.

In a second practice, each of the plural pieces 1 facing to the stage 2 has a barcode 11 as shown in FIG. 3. And the stage 2 has plural defined areas (not shown) in advance. First, recognize each of the barcodes 11 of the selected pieces 1 placed on the stage 2 via Barcode Scanning System Identification Technologies. Second, create information about the combination of the selected pieces 1 according to positions and the barcodes 11 of the selected pieces 1. Then, identify whether the combination of the selected pieces 1 is within a pre-built database described as above so as to determine if the combination is meaningful.

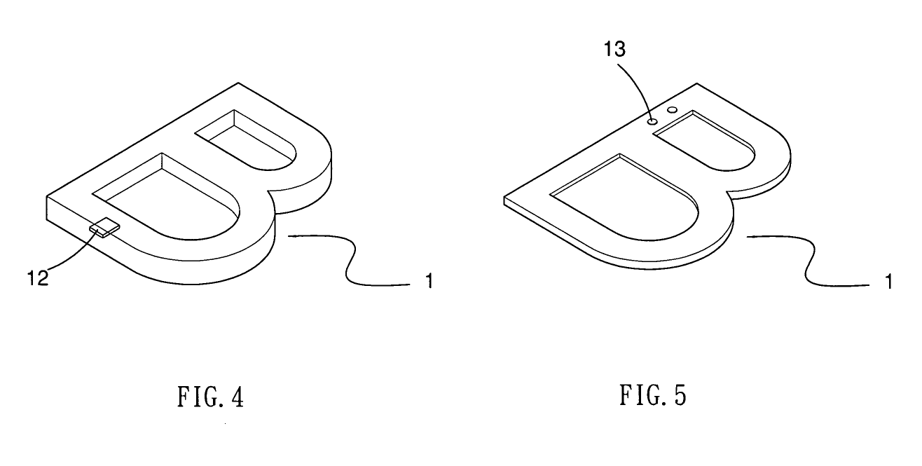

In a third practice, each piece 1 facing to the stage 2 has a Radio Frequency Identification (RFID) tag 12 as shown in FIG. 4. The RFID tag 12 can receive a first electromagnetic wave and transmit a second electromagnetic wave by using the energy provided by the first electromagnetic wave. The second electromagnetic wave carries an RFID code set in the RFID tag 12. And the stage 2 has plural defmed areas in advance. First, recognize each of the RFID codes of the selected pieces 1 placed on the stage 2 via RFID Technologies. Second, create information about the combination of the selected pieces 1 according to the positions and the RFID codes of the selected pieces 1. Then, identify whether the combination of the selected pieces 1 is within a pre-built database described as above so as to determine if the combination is meaningful.

In a fourth practice, each of the plural pieces 1 facing to the stage 2 has an Identification (ID) code formed of a certain amount of through holes 13 as shown in FIG. 5. For examples, let an A-shaped piece has one through hole, a B-shaped piece has two through holes 13 and the like. And the stage 2 has plural defmed areas in advance. First, detecting the light passing through each of the through holes 13 of the selected pieces 1 placed on the stage via Optical Detection Technologies so as to recognize the ID codes of the selected pieces 1. Second, create information about the combination of the selected pieces according to positions and the ID codes of the selected pieces 1. Then, identify whether the combination of the selected pieces 1 is within a pre-built database described as above so as to determine if the combination is meaningful.

Referred to hereinabove, it has disclosed many simple methods for recognizing the positions and the identifications of the selected pieces 1 placed on the stage 2 as described above. Therefore, the stage 2 can automatically identify the selected pieces 1 being arranged as a “BOOK” word as shown in FIG. 1. After outputting a corresponding content package, such as an audio file or a video file, the user can understand the meaning of the combination of the selected pieces through a specification of the content package, such as explaining the pronunciation, the meaning, the instruction and the example sentence or the like about the combination and enjoy it with fun.

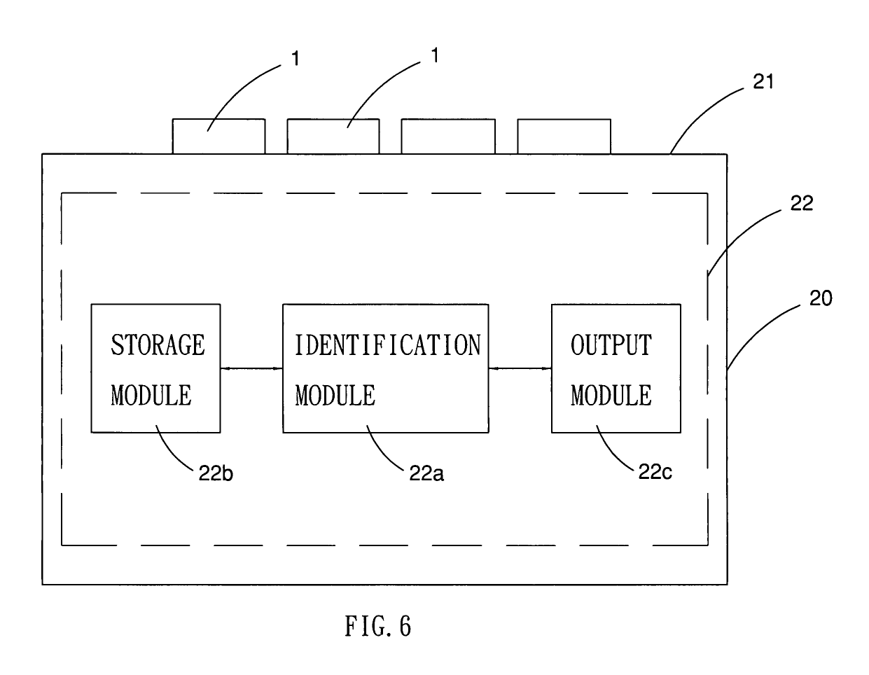

Most notably, it should be known that the stage 2 of the FIG. 1 and FIG. 6 comprises: a body 20; a panel 21, disposed on the top of the body 20 for receiving the selected pieces 1 which are chosen from the plural pieces 1 and are arrange on the panel 21 by a user, wherein the panel 21 and/or the plural pieces 1 are magnetic so as to couple to each other; and a control circuit 22, located in the body 20.

Referring to FIG. 6, the control circuit 22 comprises: an identification module 22a is provided for determining whether the combination of the selected pieces 1 placed on the panel 21 is meaningful so as to generate a corresponding information; a storage module 22b is provided for storing plural content packages, such as audio files or video files, wherein each of the content packages is to interpret the meaning of each of possible meaningful combinations of the plural pieces 1; and an output module 22c for receiving the information and retrieve the corresponding content package according to the information so as to output the corresponding content package.

Wherein, the storage module 22b is preferred as a memory card (A) as shown in FIG. 1. And the output module 22c is preferred to be a removable MP3 player (B). Thus, after identifying the combination of the selected pieces 1 placed on the stage 2 is a form of the word “BOOK” which is meaningful via the identification module 22a, and the output module 22c then retrieves a corresponding content package from the storage module 22b and runs the content package which includes the pronunciation, the meaning, the instruction and some example sentences of the word “Book”. If the content package is an MP3 format and the output module 22c is an Mp3 player, the content package can be played in Mp3 manner.

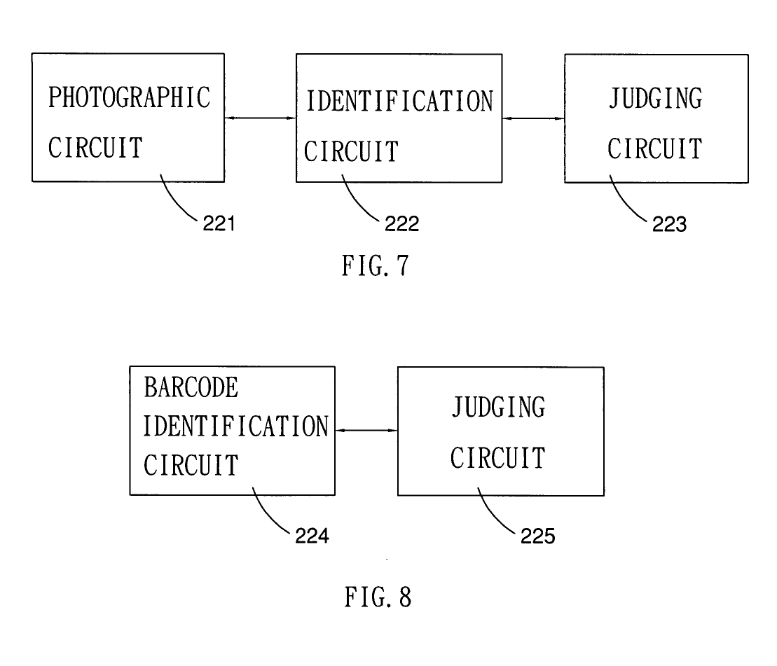

FIG. 7 shows a first practice of the identification module 22a. It's acted on the premise that the panel 21 is transparent and each of the plural pieces 1 is the type of the pieces 1 shown in FIG. 2. Wherein, the identification module 22a comprises: a photographic circuit 221, provided for retrieving the images of the selected pieces 1 placed on the panel 21 so as to identify the shaped faces of the selected pieces 1 and to form a set of image information; an identification circuit 222, provided for identifying the identifications of the selected pieces 1 according to the shaped faces of the selected pieces through analyzing the image information; and a judging circuit 223, provided for recognizing the positions where the selected pieces 1 placed and for determining whether the combination of selected pieces 1 is meaningful in accordance with the positions and the identifications of the selected pieces 1 so as to generate information.

Referring now to FIG. 8, a second practice of the identification module 22a is disclosed. It's acted on the premise that the panel 21 is transparent and has plural defined areas (not shown) for receiving the selected pieces 1 which areas shown in FIG. 3. Furthermore, the identification module 22a comprises: a barcode identification circuit 224, for scanning the barcodes 11 of the selected pieces 1 placed on the panel 21; and a judging circuit 225, provided for recognizing the positions where the selected pieces 1 placed and for determining whether the combination of selected pieces 1 is meaningful in accordance with the positions and the barcodes of the selected pieces so as to generate information.

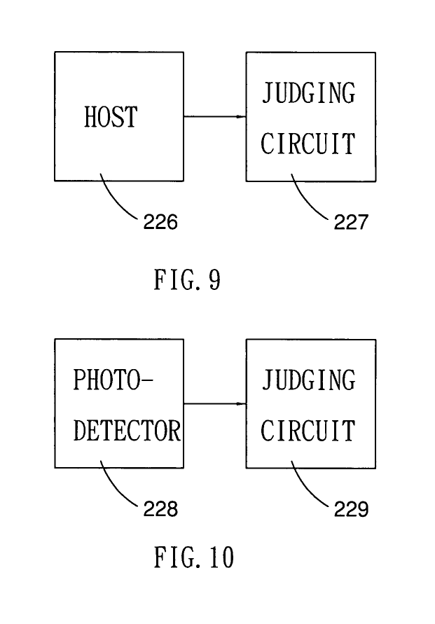

Referring now to FIG. 9, a third practice of the identification module 22a is disclosed. It's acted on the premise that the panel 21 is transparent and has plural defined areas (not shown) for receiving the selected pieces 1 as shown in FIG. 4. Furthermore, the identification module 22a comprises: a host 226, provided for transmitting the first electromagnetic wave, and both receiving and demodulating the second electromagnetic wave so as to obtain the RFID codes of the selected pieces placed 1 on the panel 21; and a judgment circuit 227, provided for recognizing the positions where the selected pieces 1 are placed and for determining whether the combination of the selected pieces 1 is meaningful according to the positions and the RFID codes of the selected pieces 1 so as to create the corresponding information.

Referring now to FIG. 10, a fourth practice of the identification module 22a is disclosed. It's acted on the premise that the panel 21 is transparent and has plural defined areas (not shown) for receiving the selected pieces as shown in FIG. 5. Furthermore, the identification module 22a comprises: a photodetector 228, provided for scanning the through holes 13 of the selected pieces 1 placed on the panel 21 so as to identify identifications of the selected pieces 1 according to light passing through the through holes 13 of the selected pieces 1; and a judgment circuit 229, provided for recognizing the positions where the selected pieces 1 are placed and for determining whether the combination of the selected pieces is meaningful according to the positions and the identifications of the selected pieces 1 so as to create the corresponding information.

As described above, the present invention discloses the stage 2 which can automatically identify the positions and the identifications of the selected pieces 1 placed on the stage 2 and determine the meaning of the combination of the selected pieces 1, and further output the content package, such as audio files or video files to explain the meaning of the combination. For examples, convey the pronunciation, the meaning, the instruction and the example sentence of the combination if the combination is a form of a word. Or if the combination is a form of a picture such a picture with three pigs and a wolf, then express the story of “the three pigs and the wolf” via audio or video manner. Yet if the combination is form of a famous painting, then specify the author, history, background, and the meaning via an audio.

Comparing with the conventional jigsaw puzzles or the spelling toys that are just pleasant to one's eyes only, the subject invention teaches the user in a fun way via the audios or videos so as to increase the learning efficiency. It's very helpful especially for preschool-aged children or blind people.

Numerous characteristics and advantages of the invention have been set forth in the foregoing description, together with details of the structure and function of the invention, and the novel features thereof are pointed out in appended claims. The disclosure, however, is illustrative only, and changes may be made in detail, especially, in matters of shape, size and arrangement of parts, materials and the combination thereof within the principle of the invention, to the full extent indicated by the broad general meaning of the terms in which the appended claims are expressed.

We claim:

1. A method for interactive learning, comprising:
a) providing a stage and plural pieces, arranged for placing on the stage;
b) creating a corresponding content package for each of possible meaningful combinations of the plural pieces;
c) identifying whether a combination formed by selected pieces is meaningful, wherein the selected pieces are chosen from the plural pieces and are arranged on the stage by a user; and
d) outputting the corresponding content package when it is identified that the combination is meaningful.

2. The method of claim 1, wherein each of the plural pieces has a shaped face, and the step c) includes:
c1) creating a corresponding identification for each of the plural pieces according to the shaped face of each of the plural pieces;
c2) recognizing positions where the selected pieces are placed on the stage;
c3) obtaining the identifications of the selected pieces according to the shaped faces of the selected pieces placed; and
c4) determining whether the combination of the selected pieces is meaningful in accordance with the positions and the identifications of the selected pieces.

3. The method of claim 1, wherein each of the plural pieces has an identification (ID) code and the step c) includes:
c1) recognizing positions where the selected pieces are placed and the ID codes of the selected pieces on the stage; and
c2) determine whether the combination of the selected pieces is meaningful in accordance with the ID codes and the positions of the selected pieces.

4. The method of claim 3, wherein the ID codes of the plural pieces are barcodes.

5. The method of claim 3, wherein the ID codes of the plural pieces are radio frequency identification (RFID) codes.

6. The method of claim 3, wherein each of the ID codes of the plural pieces is formed by a certain amount of through holes respectively.

7. An interactive learning appliance, comprising plural pieces and a stage, wherein the stage includes:
a body;
a panel deposed on a top of the body for receiving selected pieces which are chosen from the plural pieces and are arrange on the panel by a user; and
a control circuit installed in the body and including:
an identification module, provided for determining whether a combination formed by the selected pieces is a meaningful so as to generate corresponding information;
a storage module, provided for storing plural content packages, wherein each of the content packages explains the meaning of the combination of the selected pieces; and
an output module, provided for receiving the information of the identification module and outputting a corresponding content package stored in the storage module according to the information of the identification module.

8. The interactive learning appliance of claim 7, wherein the panel is transparent and each of the plural pieces has a shaped face for facing to the panel, and the identification module includes:
a photographic circuit, provided for retrieving images of the selected pieces so as to identify the shaped faces of the selected pieces;
an identification circuit, provided for recognizing identifications of the selected pieces according to the shaped faces of the selected pieces; and
a judgment circuit, provided for recognizing positions where the selected pieces placed and determining whether the combination of the selected pieces is meaningful in accordance with the positions and the identifications of the selected pieces so as to create the corresponding information.

9. The interactive learning appliance of claim 7, wherein the panel is transparent and has plural defined areas for locating the selected pieces, and wherein each of the plural pieces has a barcode for facing to the panel, and the identification module includes:
a barcode identification circuit, provided for scanning the barcodes of the selected pieces; and
a judgment circuit, provided for recognizing positions where the selected pieces are placed via the defined areas of the panel and for determining whether the combination of the selected pieces is meaningful in accordance with the positions and the barcodes of the selected pieces so as to create the corresponding information.

10. The interactive learning appliance of claim 7, wherein the panel has plural defined areas for locating the selected pieces, and each of the plural pieces has a radio frequency identification (RFID) tag which receives a first electromagnetic wave and transmits a second electromagnetic wave via energy provided by the first electromagnetic wave, and wherein the second electromagnetic wave carries an RFID code set in the RFID tag; and the identification module includes:
a host, provided for transmitting the first electromagnetic wave, and both receiving and demodulating the second electromagnetic wave so as to obtain the RFID codes of the selected pieces placed on the panel; and
a judgment circuit, provided for recognizing positions where the selected pieces are placed via the defined areas of the panel and for determining whether the combination of the selected pieces is meaningful according to the positions and the RFID codes of the selected pieces so as to create the corresponding information.

11. The interactive learning appliance of claim 7, wherein the panel is transparent and has plural defined areas for locating the selected pieces, and wherein each of the plural pieces has a certain amount of through holes for facing to the panel; and the identification module includes:
a photodetector, provided for scanning the through holes of the selected pieces so as to identify identifications of the selected pieces according to light passing through the through holes of the selected pieces; and
a judgment circuit, provided for recognizing positions where the selected pieces are placed via the defined areas of the panel and for determining whether the combination of the selected pieces is meaningful according to the positions and the identifications of the selected pieces so as to create the corresponding information.

12. The interactive learning appliance of claim 7, wherein the plural pieces are magnetic.

13. The interactive learning appliance of claim 7, wherein the panel is magnetic.
